(19) United States
(12) Patent Application Publication
(10) Pub. No.: US 2024/0177031 A1
(43) Pub. Date: May 30, 2024

(54) SYSTEM AND METHOD FOR COMPUTING EXACT SUCCESS PROBABILITY FOR QUANTILE ESTIMATION

(71) Applicant: YAHOO ASSETS LLC, Dulles, VA (US)

(72) Inventor: Eric Bax, Sierra Madre, CA (US)

(21) Appl. No.: 18/072,083

(22) Filed: Nov. 30, 2022

(51) Int. Cl. G06N 5/045

(52) U.S. Cl. CPC G06N 5/045

(57) ABSTRACT

The present teaching related to estimating quantiles. An input is received that specifies one or more quantiles to be determined from a sample obtained by sampling from a full data set. The one or more quantile estimates are indicative of corresponding quantiles by rank in the full data set within an accuracy range. The one or more quantile estimates are then determined based on the sample with a probability estimated to represent a confidence in that the one or more quantile estimates are indicative of corresponding quantiles by rank in the full data set within the accuracy range. A decision may then be made based on at least some of the one or more quantile estimates, the accuracy range, and the confidence.

### BACKGROUND

### 1. Technical Field

The present teaching generally relates to computers. More specifically, the present teaching relates to computer-based data analytics.

### 2. Technical Background

Quantile estimation is useful for data analysis, including in big-data analytics. For example, to partition a distributed set of data over machines such that each machine has a contiguous set of values within a specified number of values (within some range) in order to begin a bucket sort or in order to be able to use a single machine to search for any specified value. In these tasks, it is important to first determine which ranges of a data set includes which fractions of the values. Successful quantile estimation can be used to provide that information.

One way to estimate quantiles over a large data set of values is to sample those values uniformly without replacement and then use the sampled items at specified positions in the ranked sample as estimators of quantiles. The simplest example is using the sample item at mid-position of the samples as an estimate of the median of the data set values. Generally, let X₍₁₎, . . . , X₍ₘ₎ be a ranked size-m sample drawn uniformly without replacement from the data set values. Define rank within the data set as data set rank and rank within the sample as sample rank. The value X(r) has expected data set rank between

$$( \frac{r}{m + 1} ) n$$

and (r/m) n. The former is for sampling from a continuous distribution so it is the limit for m<<n such that sampling without replacement has little impact. The latter is obvious for m=n, as data set and sample ranks are then the same. Given that, the sample item with sample rank r may be used as an estimate of quantiles around

$$\frac{r}{m + 1}$$

or r/m.

It is often the case that one desires to use a single size-m sample to estimate multiple q quantiles, e.g., quantile r₁ (e.g., 25%), quantile r₂ (50%), . . . , quantile r_{q} (e.g., 99%). To do that, one may specify q sample ranks, r₁, . . . , r_{q}, take the sample at different sample ranks, and use the sample items with those sample ranks as quantile estimates. In some situations, a probability that each quantile estimate is accurate may also be computed, i.e., the probability that the quantile estimate corresponds to a data set rank in some specified ranges. Traditional approaches determine such a probability for each quantile estimate separately, requiring larger sample size.

Thus, there is a need for a solution that addresses the challenges discussed above associated with quantile estimation.

### SUMMARY

The teachings disclosed herein relate to methods, systems, and programming for information management. More particularly, the present teaching relates to methods, systems, and programming related to hash table and storage management using the same.

In one example, a method for estimating quantiles is disclosed. An input is received that specifies one or more quantiles to be determined from a sample obtained by sampling from a full data set. The one or more quantile estimates are indicative of corresponding quantiles by rank in the full data set within an accuracy range. The one or more quantile estimates are then determined based on the sample with a probability estimated to represent a confidence in that the one or more quantile estimates are indicative of corresponding quantiles by rank in the full data set within the accuracy range. A decision may then be made based on at least some of the one or more quantile estimates, the accuracy range, and the confidence.

In a different example, a system is disclosed for estimating quantiles, which includes a quantile estimate generator for estimating quantiles with a confidence and a quantile-based decision determine for making a decision based on estimated quantiles. The quantile estimate generator is configured for receiving a sample of a first size with a plurality of items sampled from a full data set of a second size and an input specifying one or more quantile estimates to be determined from the sample, wherein the one or more quantile estimates from the sample are indicative of corresponding quantiles by rank in the full data set within an accuracy range. The quantile estimate generator then generates the one or more quantile estimates from the sample with a probability estimated to represent a confidence in that the one or more quantile estimates are indicative of corresponding quantiles by rank in the full data set within the accuracy range. The quantile-based decision determine is configured for generating a decision based on at least some of the one or more quantile estimates, the accuracy range, and the confidence

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for estimating quantiles. The information, when read by the machine, causes the machine to perform various steps. An input is first received that specifies one or more quantiles to be determined from a sample obtained by sampling from a full data set. The one or more quantile estimates are indicative of corresponding quantiles by rank in the full data set within an accuracy range. The one or more quantile estimates are then determined based on the sample with a probability estimated to represent a confidence in that the one or more quantile estimates are indicative of corresponding quantiles by rank in the full data set within the accuracy range. A decision may then be made based on at least some of the one or more quantile estimates, the accuracy range, and the confidence.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary system diagram for a framework for generating quantile estimates with estimated confidence and an application thereof, in accordance with an embodiment of the present teaching;

FIG. 1B is a flowchart of an exemplary process of a framework for generating quantile estimates with estimated confidence and an application thereof, in accordance with an embodiment of the present teaching;

FIG. 2A depicts an exemplary system diagram for a framework for generating quantile estimates based on a sample with a size optimized based on an input confidence level, in accordance with an embodiment of the present teaching;

FIG. 2B is a flowchart of an exemplary process of a framework for generating quantile estimates based on a sample with a size optimized based on an input confidence level, in accordance with an embodiment of the present teaching;

FIG. 3A depicts an exemplary system diagram of a quantile estimate generator for producing quantile estimates from a sample with an estimated confidence level, in accordance with an embodiment of the present teaching;

FIG. 3B is a flowchart of an exemplary process of a quantile estimate generator for producing quantile estimates from a sample with an estimated confidence level, in accordance with an embodiment of the present teaching;

FIG. 4A depicts an exemplary framework for a sample size estimator based on an input confidence level, in accordance with an embodiment of the present teaching;

FIG. 4B is a flowchart of an exemplary process of a sample size estimator based on an input confidence level, in accordance with an embodiment of the present teaching;

FIG. 5 is an illustrative diagram of an exemplary mobile device architecture that may be used to realize a specialized system implementing the present teaching in accordance with various embodiments; and

FIG. 6 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses exemplary frameworks for providing quantile estimate ranks (instead of quantile estimate values) at certain accuracy level with confidence in the ranks based on a sample and the given accuracy level. The present teaching focuses on rank accuracy, instead of value accuracy, in the sense of evaluating the probability that the estimators will be within some sets of data set ranks (rather than data set values). In some embodiments of the present teaching, input may include a sample (e.g., with 1,000 sample items) from a population (e.g., 100,000,000 items), specified quantile estimate ranks to be estimated (e.g., at 50^{th} percentile, at 75^{th} percentile, at 90^{th} percentile, and at 95^{th} percentile), and an accuracy level (e.g., each quantile estimate is within 5% range of the quantile rank). The output includes the quantile estimates determined based on the given sample at the rank accuracy level and a confidence in the quantile estimate ranks (e.g., 99% confident that the quantile estimates are within 5% of the true quantiles in the population). The output confidence indicates that all quantile estimates correspond to quantiles by ranks in the full data set within the specified accuracy range.

In different embodiments of the present teaching, the method of providing quantile estimate ranks at certain accuracy level with the estimated confidence may be used to optimize (e.g., minimize) the size of an appropriate sample that can be used to estimating quantile estimates at the accuracy with a certain specified confidence level. In these embodiments, the size of the sample may be optimized first using the present teaching in providing the quantile estimates and then based on the sample of the optimized size, proceed to provide the quantile estimates at specified accuracy and confidence levels. The present teaching as disclosed herein may operate in time and space that are independent of the number of items in the data set. The approaches as described in different embodiments of the present teaching may be general for sampling in the sense that the method can be applied to any set of acceptable ranges of ranks. Details related to different embodiments of the present teaching are provided between with reference to different figures.

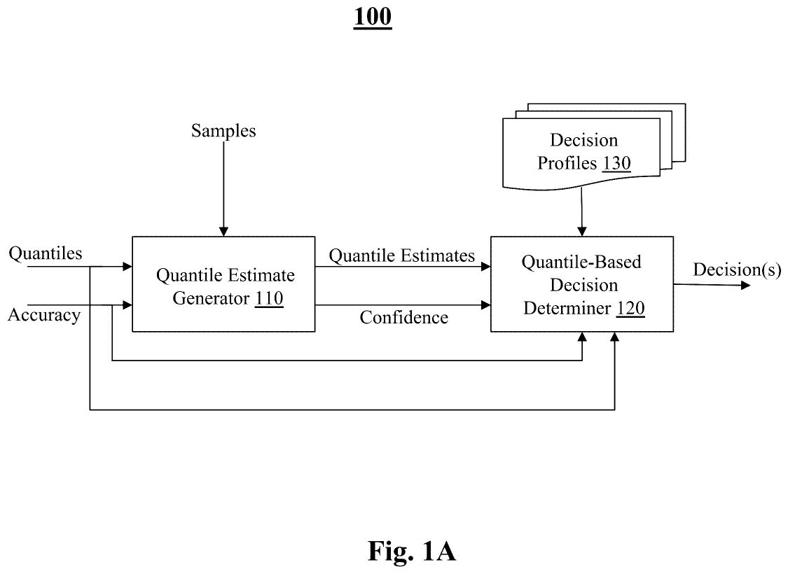

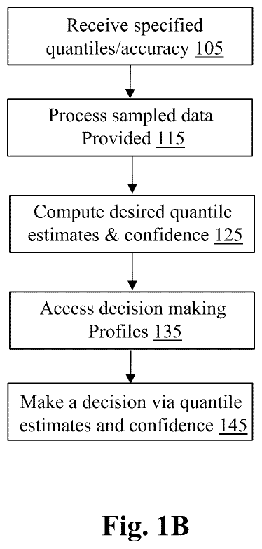

FIG. 1A depicts an exemplary system diagram for a framework 100 for generating quantile estimates with estimated confidence and its application thereof, in accordance with an embodiment of the present teaching. The framework 100 includes a quantile estimate generator 110 and a quantile-based decision determiner 120. In the illustrated embodiment, the quantile estimate generator 110 takes input which includes a sample from a population (e.g., 1,000 sample items sampled from a population of 10,000,000 items), a number of quantiles to be estimated (e.g., 75 percentile, 85 percentile, 90 percentile, and 95 percentile), and an accuracy desired (e.g., any quantile estimate produced is within 5% range of the true quantile rank in the population). Based on such inputs, the quantile estimate generator 110 produces the quantile estimates and a confidence indicative of a level of statistical confidence in the output quantile estimates (e.g., 95% confident that all of the generated quantile estimates satisfy the accuracy specified in the input).

Once the quantile estimates have a wide range of applications in business decision making. For instance, if a service provider for Voice over IP (VOIP) service needs to decide on-the-fly on what is the network bandwidth needed to deliver the service with, e.g., 99% of users finding the service quality deliver at this bandwidth level is acceptable. Given that, a 99-percentile quantile estimate is to be estimated with certain accuracy and such estimate is to be relied on to make the business decision on what is the minimum bandwidth needed to satisfy 99% of users in delivering certain VOIP services. To do so, the quantile estimates with confidence from the quantile estimate generator 110 are input to the quantile-based decision determiner 120, which makes decision(s) based on such input in accordance with some specified decision profiles stored in 130. Taking the above example on determining a network route with a certain bandwidth to deliver VOIP service, such decision profiles may specify that a communication channel with a certain bandwidth may be used to deliver VoIP service if the confidence level that 95-percentile of users, estimated with accuracy of 5% deviation from the actual situation, are happy with the service is at 99% confidence level.

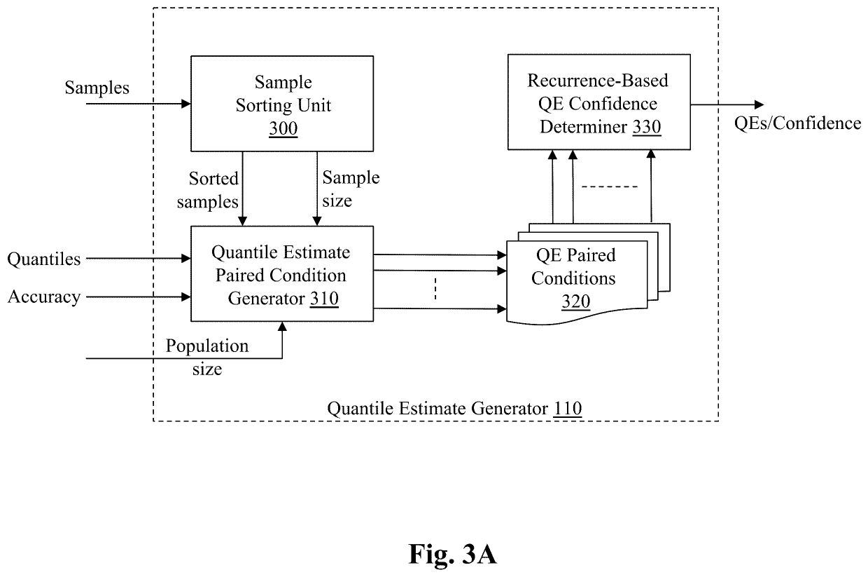

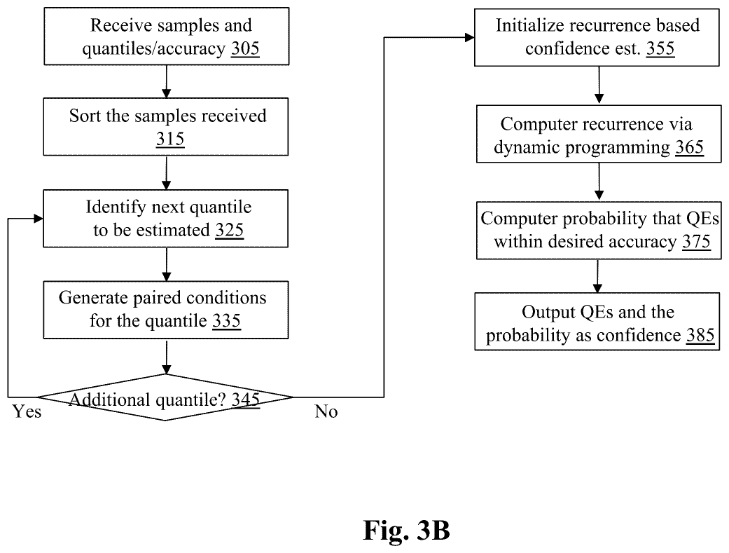

FIG. 1B is a flowchart of an exemplary process of the framework for generating quantile estimates with estimated confidence and an application thereof, in accordance with an embodiment of the present teaching. As discussed herein, in operation, when the quantile estimate generator 110 receives, at 105, input with specified quantiles to be estimated as well as a required accuracy level, it processes, at 115, the sample data provided to it in order to compute, at 125, desired quantile estimates and simultaneously the confidence for all such quantile estimates. Details of computing the quantile estimates with a confidence applicable to all such estimates will be provided below with reference to FIGS. 3A-3B. The estimated quantiles with the confidence are then sent to the quantile-based decision determiner 120, which then accesses, at 135, the decision profiles stored in 130 and makes a decision, at 145, based on the estimated quantiles at a certain accuracy level as well as the confidence in these quantile estimates.

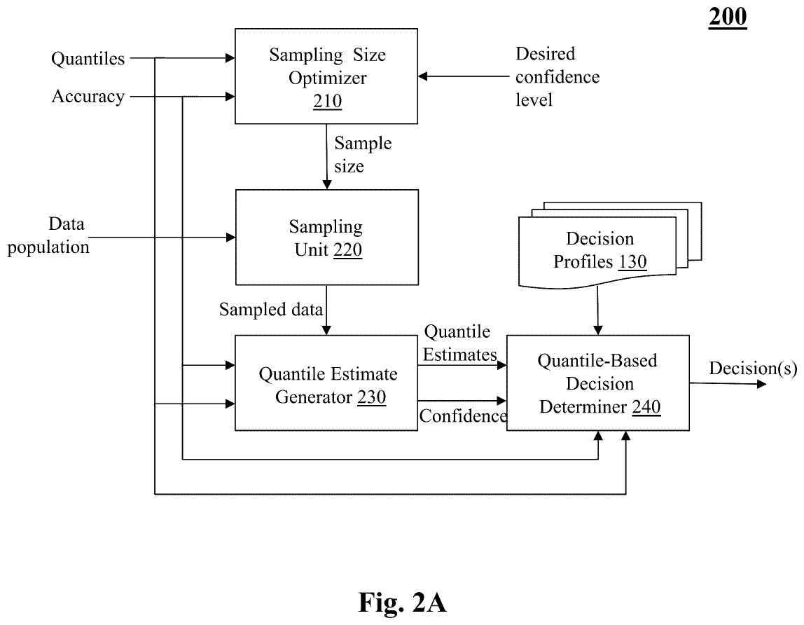

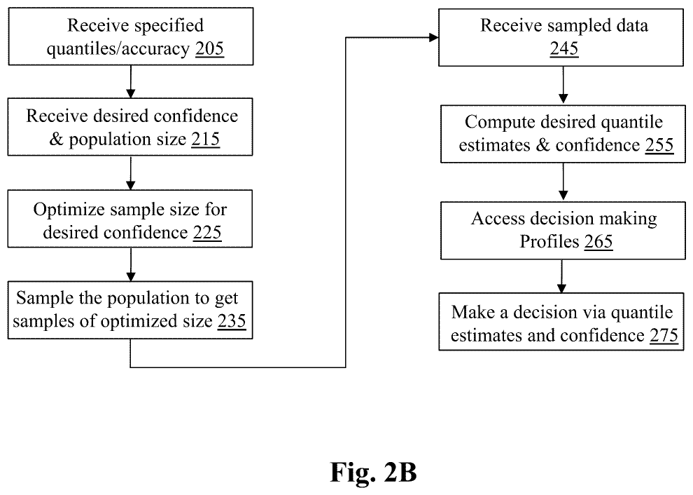

FIG. 2A depicts an exemplary system diagram for another framework 200 for generating quantile estimates based on a sample having a size optimized based on an input confidence level, in accordance with an embodiment of the present teaching. As discussed herein, the quantile estimate generator 110 may produce quantile estimates based on a given sample with a confidence in the quantile estimates. In some situations, such estimated confidence level depends on the sample size. That is, if the sample size is too small, the confidence level may accordingly be lower. In this case, an improve confidence level may be achieved by increasing the sample size. In the meantime, too large of a sample size may lead to higher cost, including the cost of sampling as well as the cost in estimating the quantile estimates. Thus, a sample size may be determined based on a confidence level to be achieved so that the sample size is optimized in the sense that it is big enough to achieve a desired confidence level but not too big to unnecessarily waste resources. In light of this, the quantile estimate generator 110 may be used to adjust or optimize a sample size in order to achieve a desired confidence level in the quantile estimates computed.

In this illustrated embodiment, the framework 200 comprises a sampling size optimizer 210, a sampling unit 220, a quantile estimate generator 230, and a quantile-based decision determiner 240. The sampling size optimizer 210 takes quantiles to be estimated, accuracy to be achieved, as well as desired confidence level as input and generates an optimized sample size so that the quantile estimates estimated from a sample with this optimized sample size may be generated with the specified accuracy and with the desired confidence level. That is, the optimized size produced by the sampling size optimizer 210 is large enough to achieve the specified accuracy and confidence but not too large to unnecessarily waste the resources on sampling and estimate the quantile estimates.

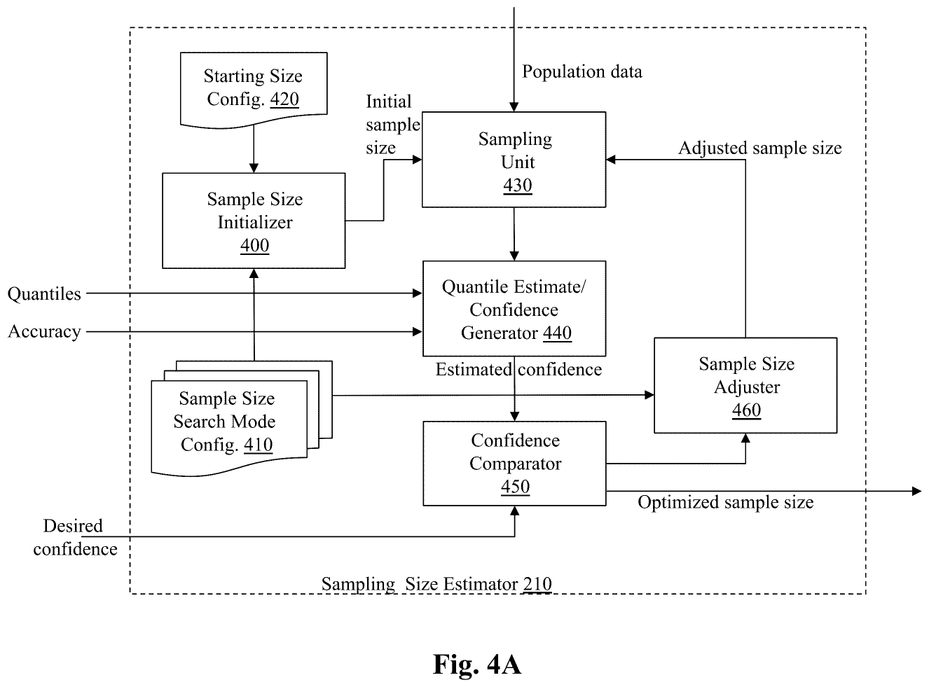

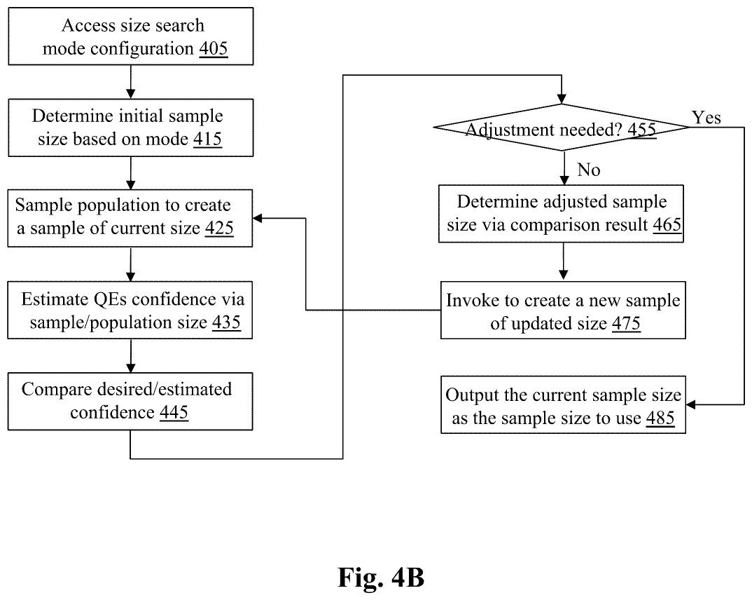

To optimize the sample size, the quantile estimation as described with reference to FIGS. 1A and 1B may be used. For example, an optimized sample size may be determined in an iterative process. Initially, a sample of a certain size may be used to perform quantile estimation to produce both quantile estimates as well as a confidence using, e.g., the quantile estimate generator 110. If the confidence produced with the quantile estimates by the quantile estimate generator 110 does not satisfy the desired confidence level, the initial sample size may be increased. Otherwise, the sample size may be decreased. The iterative process may continue until, e.g., a sample size just big enough to reach the desired confidence level. In some embodiments, the process of searching for the optimized sample size may use a binary search scheme in an ascending or a descending order. For instance, if the initial size used for the search process is 256 and the yielded confidence of the quantile estimates is lower than the specified desired confidence level, then the next sample size may be 512 (i.e., 256×2). Such binary search may end at size 1,024 as the optimized sample size, i.e., the quantile estimates generated from a sample with 1,024 sample items have a confidence that is equal or exceeds the desired confidence level. Details associated with estimating the optimal sample size are provided with reference to FIGS. 4A-4B.

Such optimized sampling size is then sent to the sampling unit 220, which samples the data population to generate a sample with the optimized size and sends the sampled data to the quantile estimate generator 230. The sampled data are then used in the same process as described above with respect to FIG. 1A. That is, the functionality of the quantile estimate generator 230 may be the same as the quantile estimate generator 110, to compute specified quantile estimates at specified accuracy based on a given sample (in this case, sampled using the optimized sampling size) with a confidence as output, where the confidence is simultaneously applicable to each and every generated quantile estimate. Similarly, the quantile-based decision determiner 240 is provided for making some business decisions based on quantile estimates of certain accuracy and confidence in accordance what is specified in decision profiles stored in 130.

FIG. 2B is a flowchart of an exemplary process of framework 200 for generating quantile estimates based on a sample with a size optimized based on an input confidence level, in accordance with an embodiment of the present teaching. In operation, when the sampling size optimizer 210 receives, at 205, specified quantile estimates to be generated, an accuracy to be achieved, and a desired confidence level on the quantile estimates, at 215, the sampling size optimizer 210 optimizes, at 225, the sample size with respect to the specified desired confidence level to produce an optimized sample size. The optimizes sample size is then used, by the sampling unit 220, to sample a given data population to generate a sample with the optimized sample size for generating the requested quantile estimates with the specified accuracy and confidence that is or above the specified desired confidence level. When the sample is received, at 245, by the quantile estimate generator 230, the quantile estimates are computed, at 255, based on the given sample, with a confidence in the estimated quantile estimates. The generates quantile estimates at specified accuracy with the estimated confidence are then used by the quantile-based decision determiner 240 to make a decision, at 275, in accordance with decision making profiles from 130 accessed at 265. Below, details related to estimating multiple quantiles based on a given sample are provided.

FIG. 3A depicts an exemplary system diagram of a quantile estimate generator for producing quantile estimates from a sample with an estimated confidence level, in accordance with an embodiment of the present teaching. As discussed herein, the quantile estimate generator may correspond to 110 or 210, both of which may be constructed the same to perform the same function. In this illustrated embodiment, the exemplary high level system diagram for the quantile estimate generator 110 is provided and it includes a sample sorting unit 300, a quantile estimate paired condition generator 310, and a recurrence-based quantile estimate (QE) confidence determiner 330. In operation, when the sample sorting unit 300 receives a sample with m items, it sorts the sample items and send the sorted result, with the sample size information m, to the quantile estimate paired condition generator 310. With the sorted sample items and size, the quantile estimate paired condition generator 310 takes input, including the quantiles to be estimated, the accuracy desired, as well as the size of the entire data set (population), and generates quantile estimate paired conditions (explained in detail below). Such generated quantile estimated conditions are then used, by the recurrence-based quantile estimate (QE) confidence determiner 330 that simultaneously estimates the quantile estimates (in ranks) with the confidence in such estimates.

The functionalities of the sample sorting unit 300, the quantile estimate paired condition generator 310, and the recurrence-based QE confidence determiner 330 are explained in more detail below. Let X₍₁₎, . . . , X₍ₘ₎ be an ordered size-m sample (X₍₁₎≤ . . . ≤X₍ₘ₎, selected uniformly at random without replacement from a size-n data set. Let r₁, . . . , r_{q} be the sample ranks of the quantile estimators: Xr₁(r), . . . , Xr_{q}). Define quantile estimation success to be that the data set rank of X₍ᵣ_{ᵢ}₎ is in [uᵢ, vᵢ] for all 1≤i≤q, for some specified values 1≤uᵢ≤vᵢ≤n. Define p* to be the probability of that success. Also define a condition (d, s, t) to be that the first d data set items (by rank) contribute between s and t (inclusive) items to the sample. The condition that the data set rank of X₍ᵣ_{ᵢ}₎ is in [uᵢ, vᵢ] is equal to (uᵢ−1,0, r₁−1)Λ(vᵢ, rᵢ, m), i.e., fewer than r₁ samples come from the first uᵢ−1 data set items, and at least r₁ come from the first vᵢ. Based on that, p* is the probability of the conjunction of 2q conditions: (u₁−1,0, r₁−1), . . . , (v_{q}, r_{q}, m).

Those 2q conditions may be ordered by their d-values. Refer to them in order of d-values as C₁, . . . , C_{2q}, with each Cᵢ=(dᵢ, sᵢ, tᵢ), so that dₕ≤ dᵢ if h<i. To ease computation of the probability p* of the conjunction of these 2q conditions, note that if h<i, then Cₕ implies that the first dₕ data set items contribute at least sₕ items to the sample, so the first dᵢ data set items must also contribute at least sₕ items. Given that, it can be set:

$$∀ i : {s}_{i} = {max}_{h \leq i} {s}_{h} \qquad ( 1 )$$

and still have an equivalent conjunction C₁ Λ . . . Λ C_{2q}. Similarly, if h>i, then Cₕ implies that the first dₕ data set items contribute at most tₕ sample items, so the first dᵢ<dₕ data set items cannot contribute more than tₕ items. Assume to set:

$$∀ i : {t}_{i} = {max}_{h \geq i} {s}_{h} ,$$

consider a general method to compute the conjunction of d-ordered (d, s, t) conditions. Let pᵢⱼ be the probability that the first i−1 conditions are satisfied and the first dᵢ data set items contribute exactly j sample items. The base cases are p₀₀=1 and pₒ_{ⱼ}=0 otherwise. By the definition of pᵢⱼ

$${p}^{*} = {\sum }_{\text{?}}^{\text{?}} \text{?}$$

$$\text{?} \text{indicates text missing or illegible when filed}$$

because the sum is over the ways to fulfill the final condition.

A recurrence holds for pᵢⱼ for sᵢ≤j≤tᵢ.

$${p}_{ij} = {\sum }_{k = \text{?}}^{min \text{?}} \text{?}$$

$$\text{?} \text{indicates text missing or illegible when filed}$$

since if the first dᵢ₋₁ data set items contribute k sample items, then the probability that the next dᵢ−dᵢ₋₁ contribute j−k if all of the other n−dᵢ₋₁ contribute a total of m−k is given by the hypergeometric distribution. Different ways may be used to computep*. In some embodiments, dynamic programming may be adopted to compute p* according to this recurrence, computing for i from 1 to 2q and for all sᵢ≤j≤ tᵢ.

The time complexity to compute p* in this way is O(qm²) as computing pᵢⱼ₋ values for 2q i-values, each number of j-values is tᵢ−sᵢ+1 which is O(m), and each computation is over at most tᵢ₋₁−sᵢ₋₁+1 terms, which is also O(m). The space complexity is O(m) as only the p_{i-1,j}-values are needed to compute the pᵢⱼ-values. Note that (by design) the time and space complexity do not depend on the data set size, but only on the number of quantile estimators and the sample size. In general, n>>m—the data set size is much larger than the sample size.

To compute the hypergeometric probabilities in the recurrence for pᵢⱼ, different approaches may be utilized with a number of terms that can provide the desired accuracy. For example, terms:

$$ln n ! \approx \qquad ( 5 )$$

$$n ln n - n + \frac{1}{2} ln ( 2 π n ) + \frac{1}{12 n} - \frac{1}{360 {n}^{3}} + \frac{1}{{1260}^{5}} - \frac{1}{1680 {n}^{7}} \qquad ( 6 )$$

may give values in a little less time with sum the terms from right to left to avoid losing contributions from the smaller terms due to roundoff errors. In this illustration, estimation of the hypergeometric probability is about O(1).

In some embodiments, to speed up the computation, instead of computing the hypergeometric probability separately for each term in the sum of the recurrence for pᵢⱼ, it may be implemented to compute only for one large term. For example, use a term with ratio (j−k): (m−j) close to (dᵢ−dᵢ₋₁):

$$( n - {d}_{i} ) , so k \approx j - \frac{( m - j ) ( {d}_{1} - {d}_{i - 1} )}{n - {d}_{i}} ,$$

or, if such a k-value is outside the summation bounds, then the nearest of the summation bounds sᵢ₋₁ or min(tᵢ₋₁, j) to it. With respect to the remaining terms, use the fact that the ratio of the hypergeometric probability for the k-term to that for the k−1-term is

$$\frac{( j - k ) [ ( n - {d}_{i} - 1 ) - ( m - k ) ]}{( m - k + 1 ) [ ( {d}_{i} - {d}_{i - 1} ) - ( j - k ) ]} . \qquad ( 7 )$$

Multiply or divide by this ratio to move forward or back (respectively) from the large term, to the summation bound or until the hypergeometric probabilities become negligible. In some embodiments, it may start with a large term because a small term may be zero at machine precision, making all multiples of it zero as well. In some embodiments, it may be implemented to compute the hypergeometric probabilities moving away from the large term but sum the terms moving from the more distant smaller terms in toward the large term, to protect against losing their contributions due to roundoff error.

In some situations, it may be implemented to compute the hypergeometric probabilities exactly (or to arbitrary precision) using exact or controlled-precision arithmetic, for example separate integer variables for numerators and denominators for exact computation and decimal. This may need additional computation for each arithmetic operation and more space for each value stored but may not increase the complexity of computing p*. As an illustration, note that each hypergeometric probability is equal to:

$$\frac{P ( {d}_{i} - {d}_{i - 1} , j - k ) P ( n - {d}_{i} , m ) ( m - k ) !}{( j - k ) ! ( m - j ) ! P ( n - {d}_{i - 1} , m - k )} , \qquad ( 8 )$$

where P(a, b)=a (a−1) . . . (a−b+1) is the product of b values. Observe that each of the three P( )-terms and factorials is the product of m or fewer terms. So direct computation requires O(m) arithmetic operations. By computing one large-valued term exactly for each pᵢⱼ computation and the others by using the ratio method discussed previously, each pᵢⱼ computation requires O(m) arithmetic operations. Since there are 2q i-values and O(m) j-values for each i, the whole computation of p* then requires O(qm²) arithmetic operations.

For direct computation with extended precision, it may be implemented by selecting the order of multiplications and divisions to balance the numerator and denominator in order to reduce roundoff errors. Extended-precision or exact computation may seem like an overkill, but it is useful sometimes as a way to check the accuracy of computation at machine precision.

In some cases, rather than estimating the quantiles of the data set, it may be needed to estimate the quantiles of a distribution for which the data set is an i.i.d. sample drawn with replacement. To do that, sample may be obtained from the data set without replacement as discussed herein. Let F( ) be the cdf of the distribution and let condition (d, s, t) mean that between s and t (inclusive) items X in the sample have F(X)<d. Then, with [uᵢ, vᵢ] as the acceptable cdf values (instead of data set ranks) for estimators, use the same method as for data set quantiles, but with a binomial instead of a hypergeometric probability in the recurrence as shown below:

$$\begin{matrix}{p}_{ij} = {\sum }_{k = \text{?}}^{min \text{?}} {p}_{i - 1 , k} ( \begin{matrix}m - k \\ j - k\end{matrix} ) {( {d}_{i} - {d}_{i - 1} )}^{j - k} {( 1 - {d}_{i} )}^{m - j} . & ( 9 )\end{matrix}$$

$$\text{?} \text{indicates text missing or illegible when filed}$$

Similar methods to those used for hypergeometric probabilities may be used for the binomial probabilities, including relying on an easy-to-compute ratio between probabilities for subsequent terms in the sum, yielding similar computation speed and space requirements. Distribution quantiles make sense for many data analysis cases, while data set quantiles make sense for determining ranges of values that have similar numbers of data set items, for example to partition the data set over machines.

Given the above exemplary formulation for determining quantile estimates, the system diagram of the quantile estimate generator 110 is provided to carry out the computation as formulated herein. As discussed above, the quantile estimate generator 110 includes a sample sorting unit 300, a quantile estimate paired condition generator 310, and a recurrence-based QE confidence determiner 330. The sample sorting unit 300 is to sort input given sample items, i.e., generating an ordered size-m sample (X₍₁₎≤ . . . ≤X₍ₘ₎ based on input samples X₍₁₎, . . . , X₍ₘ₎, selected uniformly at random without replacement from a size-n data set. The sorted samples are sent to the quantile estimate paired condition generator 310 with a known sample size m for generating, for each of the quantiles to be estimated, two conditions associated with (d, s, t) as defined above, i.e., the first d data set items (by rank) contribute between s and t (inclusive) items to the sample. As discussed herein, the condition that the data set rank of X₍ᵣ_{ᵢ}₎ is in [uᵢ, vᵢ] is equal to (uᵢ−1,0, rᵢ−1) A (vᵢ, r₁, m), i.e., fewer than r₁ samples come from the first uᵢ−1 data set items, and at least rᵢ come from the first vᵢ. In determining the paired conditions for each sample item, the quantile estimate paired condition generator 310 takes as input the sorted samples with size m as well as the specified quantiles to be estimated, the accuracy to be achieved, as well as the population size n and outputs, for each quantile to be estimated, two conditions.

Below an illustration example is provided to show the paired conditions for each quantile estimate. Assume the size of a sample is m=10,000 items from a data set of n=1 billion items. Assume also that the quantile to be estimated is 50 percentile or median. The task is to compute the probability that a median is accurately estimated from the sample. 10,000 sample items may be sorted so that sorted sample item 5000 has a rank in the entire data set between 490 million and 510 million. If this is not true, then one of the two things is true: (a) the sorted sample item 5000 comes from before data set item 490 million (by rank) or (b) this item comes from after data set item 510 million (by rank). As such, the condition (a′) the first 489,999,999 data set items (by rank) contribute fewer than 5000 items to the sample precludes (a), since if the first 490 million minus one data set items contribute less than 5000 sample items, then sample item 5000 will be a data set item with rank at least 490 million. Similarly, the condition (b′) the first 510 million data set items (by rank) contribute at least 5000 items to the sample precludes condition (b) as it implies that ranked sample item 5000 is one of the first 510 million data set items (by rank).

If (a′) and (b′) both hold, then neither (a) nor (b) hold. Given that, it can be specified that sorted sample item 5000 has a rank in the entire data set between 490 million and 510 million. In this example, q=1 as the only quantile to be estimated is median. Using the notation provided above, r₁=5000, which is the sample rank of the estimate of the median. X₅₀₀₀ is the value of the ranked sample item 5000. [uᵢ, vᵢ]=[490 million, 510 million] because that is the specified range of data set items (by rank). In this case, the two paired conditions (d, s, t) are set that the first d data set items (by rank) contribute between s and t (inclusive) items to the sample, i.e., (490 million minus one, 0, 4999) and (510 million, 5000, 10000).

Assume that another quantile, e.g., 90^{th} percentile, is also to be estimated (in addition to median) with the same accuracy, then the sorted sample item 9000 has a rank in the entire data set between 890 million and 910 million. In this example, as there are two quantiles to be estimated, so q=2. For the median estimate, r₁, [u₁, v₁], and the two paired conditions (d, s, t) for the first quantile (median) (490 million minus one, 0, 4999), (510 million, 5000, 10000) have been determined, as discussed herein. With respect to the second quantile (90^{th} percentile), r₂=9000, X₀₀₀₀ is the value of the ranked sample item 9000, and [u₂, v₂]=[890 million, 910 million]. The two paired conditions (d, s, t) for the 90^{th} percentile quantile include (890 million minus one, 0, 8999) and (910 million, 9000, 10000). Thus, the computation to determine the probability that both the median and the 90^{th} percentile quantile estimates have a given desired accuracy is carried out based on a total of four conditions:
(490 million minus one, 0, 4999)
(510 million, 5000, 10000)
(890 million minus one, 0, 8999), and
(910 million, 9000, 10000)

In some embodiments, the paired conditions for all the quantile estimates may be adjusted in accordance with equations (1) and (2) above of the present teaching. For example, if dynamic programming is used to computing the probability (confidence) via recurrence, the paired conditions may be adjusted so that the ones that all hold if and only if the original ones do and are easy to compute over. In some embodiments, to do so, the conditions may be sorted based on their d values. Taken the above example of 4 conditions, their sorted list is:
(490 million minus one, 0, 4999)
(510 million, 5000, 10000)
(890 million minus one, 0, 8999), and
(910 million, 9000, 10000)
   Then for each s value, it is replaced by the maximum of itself and the previous s values. The conditions are then become:
(490 million minus one, 0, 4999)
(510 million, 5000, 10000)
(890 million minus one, 5000, 8999) (i.e., the s value 0 now becomes 5000), and
(910 million, 9000, 10000)
   Then, for each t value, it is replaced by the minimum of itself and the subsequent t value:
(490 million minus one, 0, 4999)
(510 million, 5000, 8999) (i.e., the t value 10000 now becomes 8999)
(890 million minus one, 5000, 8999), and
(910 million, 9000, 10000)

With the adjusted conditions, recurrence is to be computed. As discussed herein, in some embodiments, dynamic programming adopted as a means to compute the recurrence as formulated above. As discussed herein, pᵢⱼ is defined as probability that the first i−1 (d, s, t) conditions hold and the first dᵢ (corresponding to the d from condition i) data set items (by rank) contribute exactly j items to the sample. As disclosed above, in some embodiments, to compute the hypergeometric probability in the recurrence of pᵢⱼ, some subroutine available from the literature may be used for that computation as follows.

hyp(N,K,n,k)=C(n,k)C(N−n,K−k)/C(N,K) where C(a,b)=a!/(b!(a−b)!).

Allocate an array p[ ][ ] of size (2q+1)×(m+1), for p[0][0] to p[2q][m]. Below is an exemplary subroutine for the computation:

```
# Base cases.
p[0][0]=1.
p[0][j] = 0 for all j > 0.
# Recurrence.
for i from 1 to 2q:
  for j from si to ti (this is s and t from condition i):
    p[i][j] = 0.0
    for k from Sᵢ₋₁ to min (tᵢ₋₁, j):
    p[i][j] = p[i][j] + p[i - 1][k] * hyp(n − dᵢ₋₁, m − k, di − dᵢ₋₁, j − k)
# Collect the answer.
pstar = 0.0
for j from s_{2q} to t_{2q}: # This is s and t from the last (d, s, t) condition.
  pstar = pstar + p[2q][j]
return pstar
```

Pᵢⱼ is the probability that the first i−1 (d, s, t) conditions hold and the first dᵢ (the d value from condition i) data set items (by rank) contribute exactly j items to the sample. At the end of the computation, each p[i][j] holds the value for pᵢⱼ.

For the base case p[0][0]=1, as there is no prior conditions, the probability that the first zero data set items contribute zero items to the sample is one. For p[0][j]=0 for j>0, the first zero data set items cannot contribute more than zero items to the sample. For the recurrence, an illustration is provided below based on the prior example.

p[3][6000]=p[3][6000]+p[2][5500]*hyp(490 million,4500,380 million,500)

This corresponds to one way to get 6000 sample items from the first d₃=890 million data set items, with the first two conditions
(490 million minus one, 0, 4999) and
(510 million, 5000, 8999)
   satisfied as well. It is to have the first 510 million data set items contribute 5500 items to the sample, with the first condition also satisfied (this has probability p[2][5500]) and also pick up 500 more sample items from the data set items starting after item 510 million and ending at item 890 million. The probability of that second part is the probability that in selecting the remaining 10000−5500=4500 sample items at random from the remaining 1 billion−510 million=490 million data set items, exactly 500 of the sample items come from the first 890 million−510 million=380 million of those 490 million remaining data set items. By the definition of the hypergeometric probability mass function, that is hyp(490 million, 4500, 380 million, 500).

For the sum to collect pstar, note that p[2q][j] is the probability that the first 2q−1 conditions are satisfied and the first d_{2q} data set items contribute j sample items. To also satisfy the last condition, j must be in the range s_{2q} to t_{2q}. So, we can sum p[2q][j] over the j-values in that range to get the probability that all conditions are satisfied. As such, this is the probability that all quantile estimates are within their specified accuracies, i.e., the confidence value that applies to all the quantile estimates. The exemplary pseudocode above takes specified quantile accuracies and a sample size as inputs and computes a confidence, i.e., the output probability that corresponds to the confidence of the estimated quantiles according to the present teaching, i.e., the probability that all quantile estimates are within their specified ranges for accuracy.

FIG. 3B is a flowchart of an exemplary process of the quantile estimate generator 110 for producing quantile estimates from a sample with an estimated confidence level, in accordance with an embodiment of the present teaching. When the sample sorting unit 300 receives, at 305, a given sample with m sample items, it sorts, at 315, the items and sends the sorted sample items to the quantile estimate paired condition generator 310 for generating, with respect to each of the quantiles to be estimated, paired conditions, as discussed herein. At 325, a next quantile to be estimated is identified and paired conditions for the identified quantile are generated by the quantile estimate paired condition generator 310 at 335. If there is more quantile, determined at 345, the operation of generating paired conditions continues to step 325. Otherwise, the operation moves to computing the confidence of the quantile estimates according to the present teaching as disclosed herein.

To compute the confidence, the recurrence based on confidence estimation is first initialized, at 355, by the recurrence-based QE confidence determiner 330, and then the recurrence is iteratively computed, at 365, via dynamic programming as discussed herein in detail. The probability that the quantile estimates are within the specified accuracy range is computed at 375. Such determined quantile estimates and the probability as confidence, as formulated in detail above, are then output, at 385.

FIG. 4A depicts an exemplary framework for the sample size estimator 210 based on an input confidence level, in accordance with an embodiment of the present teaching. As discussed herein, the above scheme of generating quantile estimates with a confidence level indicative of all quantile estimates satisfying a given accuracy range may be used to optimize the sample size for ensuring that the confidence level for quantile estimates satisfies a required level. In this case, the quantile estimation scheme as disclosed herein may be applied to search for an optimal sample size before sampling the population to create a sample. Then such sampled subset of items is known to be adequate to ensure that quantile estimates produced using the same approach may be ensured with a desired confidence level. The sample size estimator 210 is provided for generating an optimal sample size given a specified desired confidence level for a set of quantile estimates.

In this illustrated embodiment, the sample size estimator 210 comprises a sample size initializer 400, a sampling unit 430, a quantile estimate/confidence generator 440, a confidence comparator 450, and a sample size adjuster 460. The sample size initializer 400 is provided to set an initial sample size as a starting point of the search for an optimal sample size. The initial sample size may be determined based on a search mode specified by a configuration stored in 410 and a starting size specification configured in 420. In some embodiments, the search mode may be a binary search scheme (configured in 410). The initial sample size may be determined in accordance with the search mode. For instance, if a binary search mode is adopted, the initial size may be a mid-point size determined based on, e.g., a low sample size and a high sample size so that the next search direction, depending on the confidence level estimated, is in one of the two directions (binary) from the mid-point size. The mid-point initial size may be specified in 420 and used for guiding the determination of the initial sample size.

Such determined initial sample size is then sent to the sampling unit 430 that is to sample the entire data set (population) according to a given sample size. The sampled data is then used by the quantile estimate/confidence generator 440 to generate quantiles specified as input at a certain accuracy level and the confidence estimated based on the given sample of a given size. To determine whether the sample of the current estimated size is adequate to produce quantile estimates at a desired confidence level, the confidence comparator 450 compares the confidence level estimated by the quantile estimate/confidence generator 440 with the input desired confidence level. If the estimated confidence level satisfies the desired confidence level, the current sample size may be adjusted down to see if a smaller sample may still enable quantile estimation to reach the desired confidence level. If the estimated confidence level is lower than the desired confidence level, the current sample size may be increased in a manner in a search mode configured. The sample size adjuster 460 takes the comparison result from the confidence comparator 450 and make an adjustment to the sample size based on the sample size search mode configuration stored in 410 to generate an updated sample size, which is then used by the sampling unit 430 to generate a new sample of the updated size for the next iteration. The process continues until an optimized sample size is found, which is adequately large to enable quantile estimation at the desired confidence level but not too large to waste resources.

Below an exemplary search operation is provided as an illustration.

```
Start with low = 0 samples and high = n (size of entire data set).
Compute p_low (confidence for low number of samples) and p_high (confidence for high
    number of samples)
Loop: Let mid = (low + high) / 2
Compute p_mid (confidence for mid number of samples)
If p_mid < desired confidence:
  low = mid
  p_low =p_mid
Else:
  high = mid
  p_high=p_mid
If difference (low, high) < T (T is a small number)
Then return low
If p_low is at least the desired confidence and p_high otherwise
Else goto Loop.
```

FIG. 4B is a flowchart of an exemplary process of the sample size estimator 210 based on an input confidence level, in accordance with an embodiment of the present teaching. The search mode configuration for sample size is first accessed, at 405, by the sample size initializer 400 and used to determine, at 415, the initial sample size accordingly. The initial size is then used by the sampling unit 430 to create, at 425, a sample of the initial size and such a sample is then used by the quantile estimate/confidence generator 440 to estimate, at 435, the quantile estimates and the confidence that the quantile estimates satisfy the specified accuracy range. The confidence comparator 450 then compares, at 445, the confidence estimated based on the sample of the current sample size with the input desired confidence level. If the comparison result indicates that the current sample size no longer needs adjustment, determined at 455, the current sample size is output, at 485, as the optimized size. Otherwise, the sample size adjuster 460 determines, at 465, an updated sample size based on the comparison result and invokes, at 475, the sampling unit 430 to create a new sample of the update sample size. This starts a new round of operation in optimizing the sample size. In some embodiments, when the estimated confidence level does not reach the desired level, the sample size may need to be adjusted to a larger size. On the other hand, if the estimated confidence level is above the desired level, then the sample size may still need to be adjusted down to see if a smaller sample may achieve the desired confidence level in optimize the sample size.

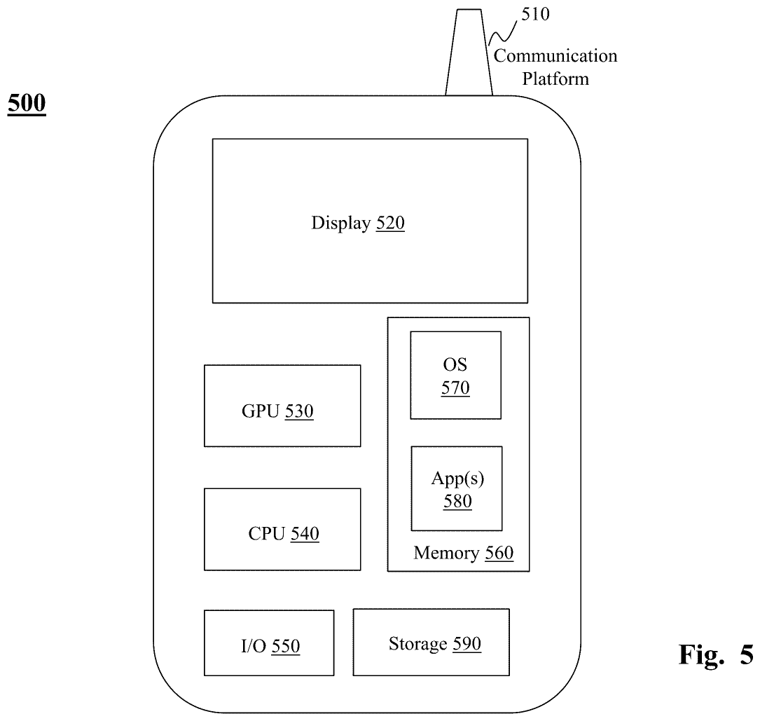

FIG. 5 is an illustrative diagram of an exemplary mobile device architecture that may be used to realize a specialized system implementing the present teaching in accordance with various embodiments. In this example, the user device on which the present teaching may be implemented corresponds to a mobile device 500, including, but not limited to, a smart phone, a tablet, a music player, a handled gaming console, a global positioning system (GPS) receiver, and a wearable computing device, or in any other form factor. Mobile device 500 may include one or more central processing units (“CPUs”) 540, one or more graphic processing units (“GPUs”) 530, a display 520, a memory 560, a communication platform 510, such as a wireless communication module, storage 590, and one or more input/output (I/O) devices 550. Any other suitable component, including but not limited to a system bus or a controller (not shown), may also be included in the mobile device 500. As shown in FIG. 5, a mobile operating system 570 (e.g., iOS, Android, Windows Phone, etc.), and one or more applications 580 may be loaded into memory 560 from storage 590 in order to be executed by the CPU 540. The applications 580 may include a user interface or any other suitable mobile apps for information analytics and management according to the present teaching on, at least partially, the mobile device 500. User interactions, if any, may be achieved via the I/O devices 550 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

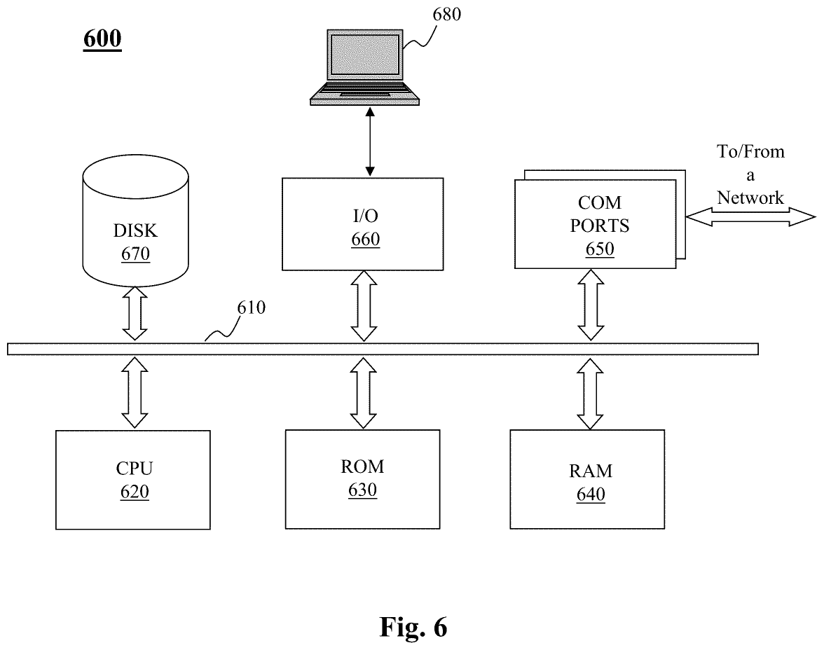

FIG. 6 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 700 may be used to implement any component or aspect of the framework as disclosed herein. For example, the information analytical and management method and system as disclosed herein may be implemented on a computer such as computer 600, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 600, for example, includes COM ports 650 connected to and from a network connected thereto to facilitate data communications. Computer 600 also includes a central processing unit (CPU) 620, in the form of one or more processors, for executing program instructions. The exemplary computer platform includes an internal communication bus 610, program storage and data storage of different forms (e.g., disk 670, read only memory (ROM) 630, or random-access memory (RAM) 640), for various data files to be processed and/or communicated by computer 600, as well as possibly program instructions to be executed by CPU 620. Computer 600 also includes an I/O component 660, supporting input/output flows between the computer and other components therein such as user interface elements 680. Computer 600 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform for estimating quantiles, comprising:
receiving a sample of a first size with a plurality of items sampled from a full data set of a second size;
receiving an input specifying one or more quantile estimates to be determined from the sample, wherein the one or more quantile estimates from the sample are indicative of corresponding quantiles by rank in the full data set within an accuracy range;
generating the one or more quantile estimates from the sample with a probability estimated to represent a confidence in that the one or more quantile estimates are indicative of corresponding quantiles by rank in the full data set within the accuracy range; and
producing a decision based on at least some of the one or more quantile estimates, the accuracy range, and the confidence.

2. The method of claim 1, wherein the step of generating comprises:
sorting the plurality of items in the sample to create an ordered list of items;
generating paired conditions for each quantile of the one or more quantile estimates, wherein the paired conditions are directed to subranges of samples by rank in the full data set contributing to subranges of items in the ordered list of items; and
computing the probability that the one or more quantile estimates satisfy the accuracy range based on the paired conditions of the one or more quantile estimates, wherein
the subranges of the samples by rank in the full data set in the paired conditions for each quantile are determined based on the quantile, the second size, and the accuracy range, and
the subranges of items in the ordered list in the paired conditions for each quantile are determined based on the first size, the quantile, and the accuracy range.

3. The method of claim 2, wherein
the probability is determined based on a plurality of successive hypergeometric probabilities; and
the hypergeometric probabilities are computed via recurrence obtained based on the paired conditions of the one or more quantile estimates.

4. The method of claim 3, wherein the recurrence is determined based on dynamic programming.

5. The method of claim 1, wherein the first size associated with the sample is determined based on a desired confidence level.

6. The method of claim 5, wherein the first size is optimized with respect to a desired confidence level by:
determining an initial first size as a current sample size;
sampling the full data set to generate a current sample of the current sample size;
estimating the one or more quantile estimates from the current sample with a probability representing a current estimated confidence in that the one or more quantile estimates from the current sample are indicative of corresponding quantiles by rank in the full data set within the accuracy range; and
comparing the desired confidence level and the current estimated confidence to determine whether the current sample size corresponds to an optimized sample size in accordance with a pre-determined sample size search scheme.

7. The method of claim 6, further comprising:
outputting the current sample size as the first size if the current sample size corresponds to an optimized sample size according to some criterion associated with the pre-determined sample size search scheme;
updating the current sample size according to the sample size search scheme if the current sample size does not correspond to the optimal sample size;
repeating the steps of sampling, estimating, comparing, outputting, and updating until the pre-determined sample search scheme yields the optimal sample size.

8. A machine readable medium having information recorded thereon for estimating quantiles, wherein the information, when read by the machine, causes the machine to perform the following steps:
receiving a sample of a first size with a plurality of items sampled from a full data set of a second size;
receiving an input specifying one or more quantile estimates to be determined from the sample, wherein the one or more quantile estimates from the sample are indicative of corresponding quantiles by rank in the full data set within an accuracy range;
generating the one or more quantile estimates from the sample with a probability estimated to represent a confidence in that the one or more quantile estimates are indicative of corresponding quantiles by rank in the full data set within the accuracy range; and
producing a decision based on at least some of the one or more quantile estimates, the accuracy range, and the confidence.

9. The medium of claim 8, wherein the step of generating comprises:
sorting the plurality of items in the sample to create an ordered list of items;
generating paired conditions for each quantile of the one or more quantile estimates, wherein the paired conditions are directed to subranges of samples by rank in the full data set contributing to subranges of items in the ordered list of items; and
computing the probability that the one or more quantile estimates satisfy the accuracy range based on the paired conditions of the one or more quantile estimates, wherein
the subranges of the samples by rank in the full data set in the paired conditions for each quantile are determined based on the quantile, the second size, and the accuracy range, and
the subranges of items in the ordered list in the paired conditions for each quantile are determined based on the first size, the quantile, and the accuracy range.

10. The medium of claim 9, wherein
the probability is determined based on a plurality of successive hypergeometric probabilities; and
the hypergeometric probabilities are computed via recurrence obtained based on the paired conditions of the one or more quantile estimates.

11. The medium of claim 10, wherein the recurrence is determined based on dynamic programming.

12. The medium of claim 8, wherein the first size associated with the sample is determined based on a desired confidence level.

13. The medium of claim 12, wherein the first size is optimized with respect to a desired confidence level by:
determining an initial first size as a current sample size;
sampling the full data set to generate a current sample of the current sample size;
estimating the one or more quantile estimates from the current sample with a probability representing a current estimated confidence in that the one or more quantile estimates from the current sample are indicative of corresponding quantiles by rank in the full data set within the accuracy range; and
comparing the desired confidence level and the current estimated confidence to determine whether the current sample size corresponds to an optimized sample size in accordance with a pre-determined sample size search scheme.

14. The medium of claim 13, further comprising:
outputting the current sample size as the first size if the current sample size corresponds to an optimized sample size according to some criterion associated with the pre-determined sample size search scheme;
updating the current sample size according to the sample size search scheme if the current sample size does not correspond to the optimal sample size;
repeating the steps of sampling, estimating, comparing, outputting, and updating until the pre-determined sample search scheme yields the optimal sample size.

15. A system for estimating quantiles, comprising:
a quantile estimate generator implemented by a processor and configured for
receiving a sample of a first size with a plurality of items sampled from a full data set of a second size,
receiving an input specifying one or more quantile estimates to be determined from the sample, wherein the one or more quantile estimates from the sample are indicative of corresponding quantiles by rank in the full data set within an accuracy range, and
generating the one or more quantile estimates from the sample with a probability estimated to represent a confidence in that the one or more quantile estimates are indicative of corresponding quantiles by rank in the full data set within the accuracy range; and
a quantile-based decision determiner implemented by a processor an configured for producing a decision based on at least some of the one or more quantile estimates, the accuracy range, and the confidence.

16. The system of claim 15, wherein the quantile estimate generator comprises:
a sample sorting unit implemented by a processor and configured for sorting the plurality of items in the sample to create an ordered list of items;
a quantile estimate paired condition generator implemented by a processor and configured for generating paired conditions for each quantile of the one or more quantile estimates, wherein the paired conditions are directed to subranges of samples by rank in the full data set contributing to subranges of items in the ordered list of items; and
a recurrence-based quantile estimate confidence determiner implemented by a processor and configured for computing the probability that the one or more quantile estimates satisfy the accuracy range based on the paired conditions of the one or more quantile estimates, wherein
the subranges of the samples by rank in the full data set in the paired conditions for each quantile are determined based on the quantile, the second size, and the accuracy range, and
the subranges of items in the ordered list in the paired conditions for each quantile are determined based on the first size, the quantile, and the accuracy range.

17. The system of claim 16, wherein
the probability is determined based on a plurality of successive hypergeometric probabilities; and
the hypergeometric probabilities are computed via recurrence obtained via dynamic programming with respect to the paired conditions of the one or more quantile estimates.

18. The system of claim 15, wherein the first size associated with the sample is determined based on a desired confidence level.

19. The method of claim 18, further comprising a sample size optimizer implemented by a processor and configured for optimizing the first size with respect to a desired confidence level by:
determining an initial first size as a current sample size;
sampling the full data set to generate a current sample of the current sample size;
estimating the one or more quantile estimates from the current sample with a probability representing a current estimated confidence in that the one or more quantile estimates from the current sample are indicative of corresponding quantiles by rank in the full data set within the accuracy range; and
comparing the desired confidence level and the current estimated confidence to determine whether the current sample size corresponds to an optimized sample size in accordance with a pre-determined sample size search scheme.

20. The system of claim 19, wherein the sample size optimizer is further configured for:
outputting the current sample size as the first size if the current sample size corresponds to an optimized sample size according to some criterion associated with the pre-determined sample size search scheme;
updating the current sample size according to the sample size search scheme if the current sample size does not correspond to the optimal sample size;
repeating the steps of sampling, estimating, comparing, outputting, and updating until the pre-determined sample search scheme yields the optimal sample size.
